(19) United States
(12) Patent Application Publication
(10) Pub. No.: US 2008/0263328 A1
(43) Pub. Date: Oct. 23, 2008

(54) ORTHOGONAL REGISTER ACCESS

(75) Inventors: Timothy Williams, Bellevue, WA (US); Gregory John Verge, Lynnwood, WA (US); Dennis Seguine, Monroe, WA (US)

Correspondence Address: Stolowitz Ford Cowger, LLP/Cypress, 621 Sw Morrison St., Suite 600, Portland, OR, 97205, US

(73) Assignee: CYPRESS SEMICONDUCTOR CORPORATION, San Jose, CA (US)

(21) Appl. No.: 11/859,547

(22) Filed: Sep. 21, 2007

Related U.S. Application Data
(60) Provisional application No. 60/912,399, filed on Apr. 17, 2007.

(51) Int. Cl. G06F 9/38

(52) U.S. Cl. 712/212; 712/E09.072

(57) ABSTRACT

Embodiments of the invention relate to a method and system for accessing a set of parallel registers orthogonally. A decoder may be used to select a particular row or column of the set of parallel registers to perform register operations in a parallel fashion corresponding to the selected row or in an orthogonal fashion corresponding to the selected column. Thus, when a particular row is selected, a register operation may be carried out for each bit of the selected row to produce a parallel register output, such as by reading/writing each bit of the selected row to a parallel register. On the other hand, when a particular column is selected, a register operation may be carried out for each bit of the selected column, such as by reading/writing each bit of the selected column to an orthogonal register. The orthogonal register access allows for fast and efficient access to a particular bit in the set of parallel registers.

### RELATED APPLICATIONS

This application claims the benefit of U.S. Provisional Application No. 60/912,399, filed Apr. 17, 2007, which is incorporated herein by reference.

### TECHNICAL FIELD

The present disclosure relates generally to Integrated Circuits (ICs), and more particularly to a method and system to access a set of parallel registers orthogonally.

### BACKGROUND

A variety of devices, e.g., central processing unit (CPU) or other electronic device s, may comprise therein registers to control various functions. Typically, these registers may be implemented in a parallel fashion, such as a parallel register in which data may be read from and/or written to the parallel register concurrently. However, there may be instances in which only a particular bit in a set of parallel registers needs to be accessed to control certain functions. For example, for an 8-bit input and output (I/O) port, it may take 3 bits in a set of parallel registers to define a particular mode for a particular I/O bit, e.g., bit 3 of a set of three parallel registers may define the mode, and thus take three 8-bit parallel registers to fully describe the 8-bit I/O port. To set the mode for only one of the bits in the 8-bit I/O port, all three 8-bit parallel registers may have to be sequentially written, which can be both inefficient and time-consuming.

### DESCRIPTION OF EXAMPLE EMBODIMENTS

### Overview

A system includes a plurality of parallel registers, each storing multiple register bits; and a decoder to access a first set of register bits in the plurality of parallel registers in an orthogonal fashion to produce an orthogonal register output, responsive to an orthogonal access command. The decoder may also access a second set of register bits in the plurality of parallel registers in a parallel fashion to produce a parallel register output, responsive to a parallel access command. The decoder is configured to generate a row select signal for selecting a row from the plurality of parallel registers, or to generate a column select signal for selecting a column from the plurality of parallel registers. The system further comprises a selector coupled to each register bit of the plurality of parallel registers to select between the parallel register output and the orthogonal register output.

A method includes providing a plurality of parallel registers, each parallel register storing multiple register bits; and accessing a first set of register bits in the plurality of parallel registers in an orthogonal arrangement to produce an orthogonal register output, responsive to an orthogonal access command. The method further comprises accessing a second set of register bits in the plurality of parallel registers in a parallel arrangement to produce a parallel register output, responsive to an parallel register access command. The method comprises selecting one of a row or column from the plurality of parallel registers, wherein the selected row corresponds to the parallel arrangement, and wherein the selected column corresponds to the orthogonal arrangement; performing an operation for the selected row or column; generating the parallel register output from the selected row; and generating the orthogonal register output from the selected column.

### BRIEF DESCRIPTION OF THE DRAWINGS

The foregoing and other objects, advantages and features will become more readily apparent by reference to the following detailed description in conjunction with the accompanying drawings.

FIG. 1 is a block diagram illustrating an example orthogonal register access system according to embodiments of the invention.

FIG. 2 is a block diagram illustrating a logical mapping between a logical register map and a bank of physical registers according to the orthogonal register access system of FIG. 1.

FIG. 3 is a schematic block diagram illustrating an example system to implement an orthogonal register access.

FIG. 4 is an example flow diagram illustrating an orthogonal register access.

### DETAILED DESCRIPTION

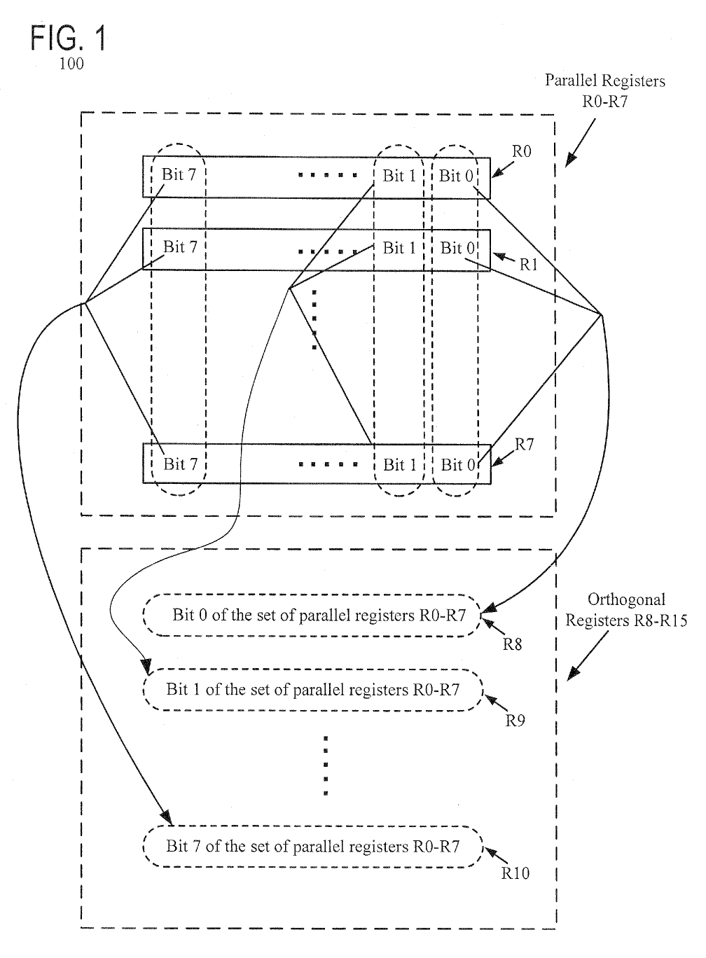

FIG. 1 is a block diagram illustrating an example orthogonal register access system 100 according to embodiments of the invention. Referring to FIG. 1, system 100 may include a set of parallel registers, such as parallel registers R0-R7. Each of these parallel register R0-R7 may store 8-bit data, such as bit 0, bit 1 . . . , and bit 7. Although FIG. 1 shows only eight 8-bit parallel registers, system 100 may include any number of parallel registers, each of which may store any number bits of data, e.g., 16-bit data or 32-bit data, etc.

A particular bit in the set of parallel registers, such as bit 0s, bit 1s, . . . , or bit 7s of the parallel registers R0-R7, may be accessed orthogonally by reading from and/or writing to one of the plurality of orthogonal register R8-R15. For example, as shown in FIG. 1, all bit 0s of the set of parallel registers R0-R7 may be accessed via orthogonal register R8, all bit 1s of the set of parallel registers R0-R7 may be accessed via orthogonal register R9, and so forth. It should be noted, however, that bit 0s, bit 1s, . . . , or bit 7s of the set of parallel registers R0-R7 may be accessed via any of the orthogonal registers R8-R15. For example, all bit 0s in the set of parallel registers R0-R7 may be accessed via orthogonal register R10, while all bit 1s of the set of parallel registers R0-R7 may be accessed via orthogonal register R12.

The parallel registers R0-R7 may be implemented using physical storage elements, while the orthogonal registers R8-R15 may be implemented as virtual registers. An example implementation of the orthogonal register access system 100 will be described below in greater detail. Although FIG. 1 shows only eight orthogonal registers R8-R15, system 100 may include any number of orthogonal registers as needed. Additionally, each of the orthogonal registers R8-R15, may store may store any number bits of data, e.g., 8-bit, 16-bit data, etc.

Thus, instead of accessing sequentially through the parallel registers R0-R7 in order to access a particular bit in the set of parallel registers R0-R7, system 100 may access a particular bit in the set of parallel registers R0-R7 via an orthogonal register, such as the orthogonal registers R8-R15. System 100 thus allows for fast and efficient access to a particular bit in the set of parallel registers R0-R7.

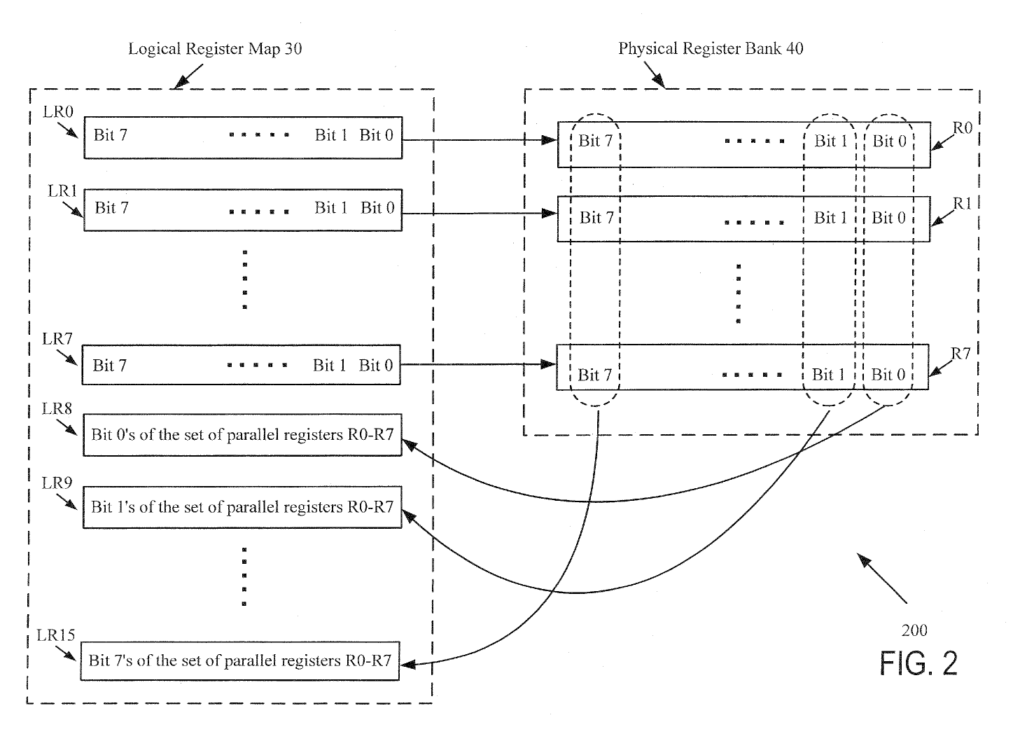

FIG. 2 is a block diagram illustrating a logical mapping 200 between a logical register map 30 and a physical registers 40 according to the orthogonal register access system of FIG. 1. Referring to FIG. 2, the logical register map 30 may include a plurality of logical registers LR0-LR15. Each of the logical registers LR0-LR15 may store 8-bit data, or any number bits of data, such as 16-bit or 32-bit data. The physical register bank 40 may include a plurality of parallel registers R0-R7 that may be implemented using physical storage elements. Each of the parallel registers R0-R7 may store 8-bit data as shown in FIG. 2 or any number bits of data. Although FIG. 2 shows that the logical register map 30 includes sixteen logical registers LR0-LR15, whereas the physical register bank 40 includes eight parallel registers R0-R7, the logical register map 30 and the physical register bank 40 may each include any number of logical registers and parallel registers, respectively.

A subset of the logical registers LR0-LR15 may be matched directly to the set of parallel registers R0-R7, while another subset of the logic parallel registers LR0-LR15 may be matched to the individual bits within the parallel registers R0-R7 in an orthogonal fashion. For instance, logical register LR15 may map to all bit 7s in physical registers R0-R7.

In some embodiments, the logical registers LR0-LR7 may each be matched to one of the physical registers R0-R7, e.g., logical registers LR0 may be matched to parallel registers R0, logical register LR1 may be matched to parallel register R1, . . . , and logical register LR7 may be matched to parallel register R7. On the other hand, each of the logical registers LR8-LR15 may be matched orthogonally to the individual bits within the physical parallel registers R0-R7, e.g., logical register LR8 may be matched to all bit 0s of the parallel registers R0-R7, logical register LR9 may be matched to all bit 1s of the parallel registers R0-R7, . . . , and logical register LR15 may be matched to all bit 7s of the parallel registers R0-R7. In other words, the logical registers LR0-LR7 may each be matched to one of the parallel registers R0-R7, while the logical registers LR8-LR15 may each be matched to one of the orthogonal registers R8-R15.

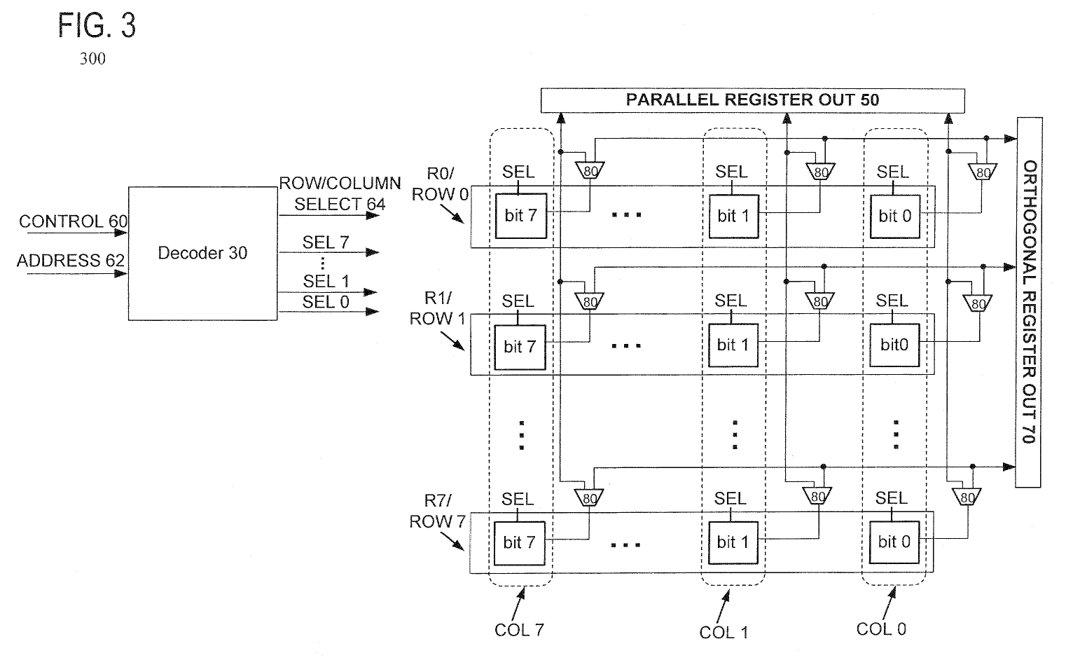

FIG. 3 is a schematic block diagram illustrating an example system 300 for implementing an orthogonal register access. It should be recognized that FIG. 3 may include other elements, which are not illustrated in order to simplify the figures and which may not necessary to understand the example system disclosed below.

Referring to FIG. 3, system 300 may include a decoder 30 and a set of parallel registers R0-R7. The parallel registers R0-R7 may be accessed in a parallel fashion, e.g., via rows ROW0, ROW 1, . . . , or ROW 7, or in an orthogonal fashion, e.g., via columns COL 0, COL 1, . . . , or COL 7. Each row ROW 0-ROW 7 and each column COL 0-COL 7 may respectively be assigned a unique address such that only a particular row or column may be accessed during a register operation, e.g., read/write to the selected row or column.

When a particular row ROW 0-ROW 7 or a particular column COL 0-COL 7 is to be accessed, the decoder 30 may first decode an address 62 placed on an address bus (not shown). The decoder 30 may also receive control signals 60 from a processor or host device (not shown). The control signals 60 may include read/write operation commands, as well as other control commands. Based on the decoded address, the decoder 30 may select a particular row ROW 0-ROW 7 or a particular column COL 0-COL 7 by generating a ROW or COLUMN SELECT signal 64 and one of SEL 0, SEL 1, SEL2, . . . , or SEL 7 signal. Although FIG. 3 shows that the decoder 30 outputs SEL 0-SEL 7 signals, the decoder 30 may output SEL 0-SEL n signals, where n>=0.

Table 1 below illustrates an example address decoding by decoder 30 for a 4-bit address 62. Although Table 1 shows that the address 62 is only 4 bits long, the decoder 30 may decode any address of arbitrary length, e.g., 16-bit address, or 32-bit address.

TABLE 1

| Address 62 | Decoder 30 Output |
|---|---|
| 0000 | ROW SELECT, SEL 0 (enable ROW 0) |
| 0001 | ROW SELECT, SEL 1 (enable ROW 1) |
| 0010 | ROW SELECT, SEL 2 (enable ROW 2) |
| 0011 | ROW SELECT, SEL 3 (enable ROW 3) |
| 0100 | ROW SELECT, SEL 4 (enable ROW 4) |
| 0101 | ROW SELECT, SEL 5 (enable ROW 5) |
| 0110 | ROW SELECT, SEL 6 (enable ROW 6) |
| 0111 | ROW SELECT, SEL 7 (enable ROW 7) |
| 1000 | COL SELECT, SEL 0 (enable COL 0) |
| 1001 | COL SELECT, SEL 1 (enable COL 1) |
| 1010 | COL SELECT, SEL 2 (enable COL 2) |
| 1011 | COL SELECT, SEL 3 (enable COL 3) |
| 1100 | COL SELECT, SEL 4 (enable COL 4) |
| 1101 | COL SELECT, SEL 5 (enable COL 5) |
| 1110 | COL SELECT, SEL 6 (enable COL 6) |
| 1111 | COL SELECT, SEL 7 (enable COL 7) |

As shown in Table 1, when address 62 is “0000”, decoder 30 may generate a ROW SELECT signal 64 and SEL 0 signal at the output to enable ROW 0. On the other hand, when address 62 is “1000”, decoder 30 may generate a COL SELECT signal 64 and COL 0 at the output to enable COL 0.

Once a particular row ROW 0-ROW 7 is selected or enabled, a register operation may be performed for each bit in the selected row to produce a parallel register output 50 such as by reading or writing each bit of the selected row to a parallel register e.g., the parallel registers R0-R7). Similarly, once a particular column COL 0-COL 7 is selected, a register operation may be performed for each bit in the selected column to produce an orthogonal register output 70, such as by reading or writing each bit in the selected column to an orthogonal register, e.g., the orthogonal registers R8-R15. For example, when ROW 0 is enabled, then bit 0, bit 1, . . . , and bit 7 of ROW 0 may be enabled, e.g., the “SEL” signal associated with each of bit 0, bit 1, . . . , and bit 7 may be used to indicate that the particular bit is selected, to carry out a register operation, and thus produce a parallel register output 50. On the other hand, when COL 0 is enabled, then all bit 0s in COL 0 may be enabled, e.g., the “SEL” signals of bit 0 of R0, bit 0 of R1, . . . , and bit 0 of R7 may be used to indicated that the particular bit is enabled, to perform a register operation, and thus produce an orthogonal register output 70. Although it is not shown in FIG. 3, a data bus may be used to transfer data between the selected row/column and a processor or host device (not shown).

Selector logic 80 may be used at an output of each register bit, e.g., bit 0, bit 1, . . . , and bit 7, to select between the parallel register output 50 and the orthogonal register output 70. That is, if a parallel register output 50 is selected, then the register bit may be accessed in a parallel fashion by reading or writing the register bit to a parallel register, such as parallel registers R1-R7, else if an orthogonal register output 70 is selected, then the register bit may be accessed in an orthogonal fashion by reading or writing the register bit to an orthogonal register, such as orthogonal registers R8-R15. Although FIG. 3 shows only eight 8-bit parallel registers R0-R7, system 300 may include any number of parallel registers, each of which may store any number bits of data, e.g., 16-bit or 32-bit, etc.

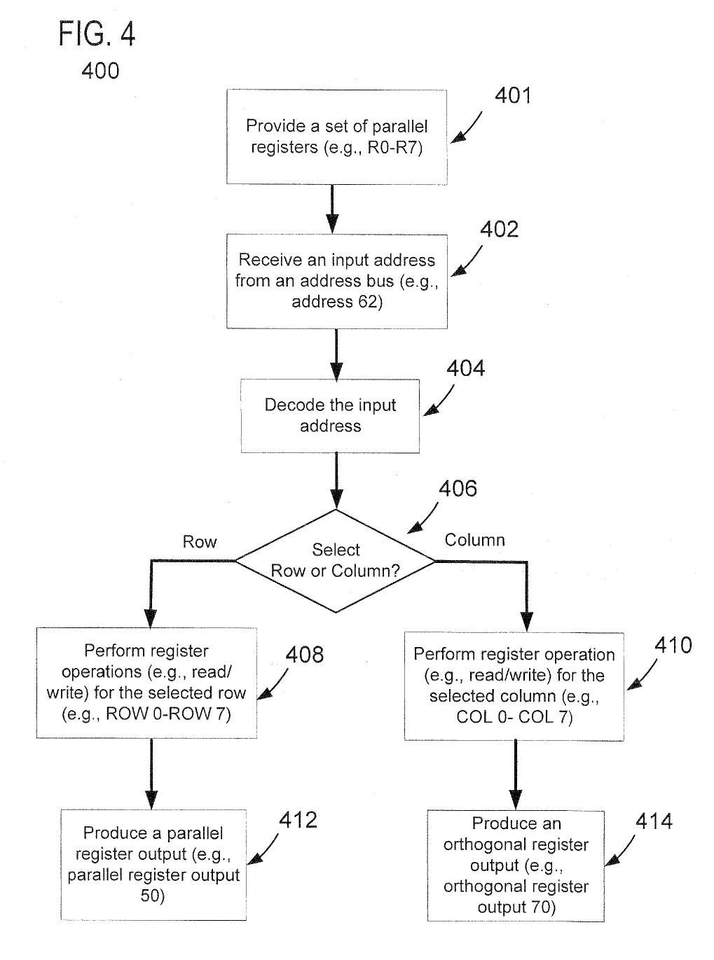

FIG. 4 is an example flow diagram 400 illustrating an orthogonal register access. Referring to FIG. 4, at a block 401, a system provides a set of parallel registers, e.g., R0-R7. The parallel registers may be accessed in a parallel fashion, e.g., via rows ROW0, ROW 1, . . . , or ROW 7, or in an orthogonal fashion, e.g., via columns COL 0, COL 1, . . . , or COL 7. Each row and each column of the parallel registers may respectively be assigned a unique address such that only a particular row or column may be accessed during a register operation, e.g., read/write to the selected row or column. At block 402, the system receives an input address from an address bus, e.g., address 62. The input address may correspond to the address of a particular row or column in the parallel registers. At block 404, the system decodes the input address using an address decoding table, e.g., Table 1. At decision block 406, based on the decoded input address, the system selects a particular row or column that has an address matching the input address to carry out a register operation, e.g., read/write. If a row is selected, then at block 408, the system performs a register operation for each bit in the selected row, such as by reading/writing bit 0, bit 1, . . . , and bit 7 of the selected row to a parallel register. At block 412, the system produces a parallel register output, such as parallel register output 50. On the other hand, if a column is selected, then at block 410, the system performs a register operation for each bit in the selected column such as by reading/writing each bit of the selected column to one of the orthogonal registers R8-R15. At block 414, the system produces an orthogonal register output, such as orthogonal register output 70.

Embodiments of the invention relate to a method and system for accessing a set of parallel registers orthogonally. A decoder may be used to select a particular row or column of the set of parallel registers to perform register operations in a parallel fashion or in an orthogonal fashion. Thus, when a particular row is selected, a register operation may be carried out in a parallel fashion for each bit of the selected row to produce a parallel register output, such as by reading/writing each bit of the selected row to a parallel register. On the other hand, when a particular column is selected, a register operation may be carried out for each bit of the selected column, such as by reading/writing each bit of the selected column to an orthogonal register. The orthogonal register access allows for fast and efficient access to a particular bit in the set of parallel registers.

Further modifications and alternative embodiments of this invention will be apparent to those skilled in the art in view of this description. Accordingly, this description is to be construed as illustrative only and is for the purpose of teaching those skilled in the art the manner of carrying out the invention. Various changes may be made in the shape, size and arrangement and types of components or devices. For example, equivalent elements or materials may be substituted for those illustrated and described herein, and certain features of the invention may be utilized independently of the use of other features, all as would be apparent to one skilled in the art after having the benefit of this description of the invention. Alternative embodiments are contemplated and are within the spirit and scope of the following claims.

1. A system, comprising:
a plurality of parallel registers, each storing multiple register bits; and
a decoder to access a first set of register bits in the plurality of parallel registers in an orthogonal fashion to produce an orthogonal register output, responsive to an orthogonal access command.

2. The system of claim 1, wherein the orthogonal access command comprises an orthogonal register address, a read operation, a write operation, or a combination thereof.

3. The system of claim 1, wherein the decoder is configured to generate a column select signal for selecting a column from the plurality of parallel registers.

4. The system of claim 3, wherein the first set of register bits corresponds to the selected column of the plurality of parallel registers.

5. The system of claim 1, wherein the decoder accesses a second set of register bits in the plurality of parallel registers in a parallel fashion to produce a parallel register output, responsive to a parallel access command.

6. The system of claim 5, wherein the parallel access command comprises a parallel register address, a read operation, a write operation, or a combination thereof.

7. The system of claim 5, wherein the decoder is configured to generate a row select signal for selecting a row from the plurality of parallel registers, responsive to the parallel access command.

8. The system of claim 7, wherein the second set of register bits corresponds to the selected row of the plurality of parallel registers.

9. The system of claim 5, further comprising a selector coupled to each register bit of the plurality of parallel registers to select between the parallel register output and the orthogonal register output.

10. A method, comprising:
providing a plurality of parallel registers, each parallel register storing multiple register bits; and
accessing a first set of register bits in the plurality of parallel registers in an orthogonal arrangement to produce an orthogonal register output, responsive to an orthogonal access command.

11. The method of claim 1, further comprising accessing a second set of register bits in the plurality of parallel registers in a parallel arrangement to produce a parallel register output, responsive to an parallel register access command.

12. The method of claim 11, further comprising:
selecting one of a row or column from the plurality of parallel registers, wherein the selected row corresponds to the parallel arrangement, and wherein the selected column corresponds to the orthogonal arrangement;
performing an operation for the selected row or column;
generating the parallel register output from the selected row; and
generating the orthogonal register output from the selected column.

13. The method of claim 12, wherein selecting one of the row or column comprises generating a row select signal.

14. The method of claim 12, wherein selecting one of the row or column comprises generating a column select signal.

15. The method of claim 12, wherein performing the operation for the selected row or column comprises performing a read or write operation for each register bit of the selected row or column.

16. The method of claim 12, wherein generating the parallel register output from the selected row comprises reading or writing each register bit in the selected row to a parallel register.

17. The method of claim 12, wherein generating the orthogonal register output from the selected column comprises reading or writing each register bit in the selected column to an orthogonal register, the orthogonal register being a virtual register.

18. A system, comprising:
means for providing a plurality of parallel registers, each storing multiple register bits; and
means for accessing a first set of register bits in the plurality of parallel registers in an orthogonal fashion to produce an orthogonal register output, responsive to an orthogonal access command.

19. The system of claim 18, further comprising means for accessing a second set of register bits in the plurality of parallel registers in a parallel fashion to produce a parallel register output, responsive to a parallel access command.

20. The system of claim 18, further comprising:
means for selecting one of a row or column from the plurality of parallel registers, wherein the selected row corresponds to the parallel arrangement, and wherein the selected column corresponds to the orthogonal arrangement;
means for performing an operation for the selected row or column;
means for generating the parallel register output from the selected row; and
means for generating the orthogonal register output from the selected column
